(19) United States
(12) Patent Application Publication
(10) Pub. No.: US 2020/0245033 A1
(43) Pub. Date: Jul. 30, 2020

(54) DISPLAY APPARATUS AND CONTROLLING METHOD THEREOF

(71) Applicant: SAMSUNG ELECTRONICS CO., LTD., Suwon-si (KR)

(72) Inventors: Eun-joo CHO, Hwaseong-si (KR); Young-sun KIM, Suwon-si (KR); Myung-kwan CHOI, Suwon-si (KR); Seung-whan KIM, Seongnam-si (KR); A-rum CHOI, Seongnam-si (KR)

(73) Assignee: SAMSUNG ELECTRONICS CO., LTD., Suwon-si (KR)

(21) Appl. No.: 16/845,468

(22) Filed: Apr. 10, 2020

Related U.S. Application Data
(63) Continuation of application No. 15/373,041, filed on Dec. 8, 2016.
(60) Provisional application No. 62/309,078, filed on Mar. 16, 2016.

(30) Foreign Application Priority Data
Jul. 7, 2016 (KR) 10-2016-0086138

(51) Int. Cl. H04N 21/482; H04N 21/25; H04N 21/485; H04N 21/61; H04N 21/462

(52) U.S. Cl. CPC H04N 21/4826; H04N 21/251; H04N 21/4821; H04N 21/4383; H04N 21/6125; H04N 21/4622; H04N 21/4858

(57) ABSTRACT

The display apparatus includes a display; a transceiver configured to receive a plurality of Internet broadcasting contents; an input unit configured to receive an user input signal; and a processor configured to, in response to receiving, through the input unit, an user input signal for selecting a predetermined virtual channel number, control the display to display information of a plurality of virtual channels. The plurality of virtual channels correspond to the plurality of Internet broadcasting contents receivable through the transceiver, and the information of the plurality of virtual channels includes at least one of virtual channel numbers, icons for the virtual channels, and virtual channel names.

### CROSS-REFERENCE TO RELATED APPLICATIONS

This is a continuation of U.S. application Ser. No. 15/373,041 filed Dec. 8, 2016, which claims benefit of U.S. Provisional Application No. 62/309,078, filed on Mar. 16, 2016, and claims priority from Korean Patent Application No. 10-2016-0086138, filed in the Korean Intellectual Property Office on Jul. 7, 2016, the disclosures of which are incorporated herein by references in their entireties.

### BACKGROUND

### 1. Field

The present disclosure relates to a display apparatus and a controlling method thereof, and more particularly, to a display apparatus which assigns a channel number to a channel recommendation screen and provides a user with the channel number.

### 2. Description of Related Art

With the recent development of various multimedia apparatuses, a user can watch diverse broadcasting programs whenever and wherever a user wants to without limitations. Moreover, as many contents that can be provided through a broadcasting channel develops, the number of channels that a user can watch more increase.

In general, a user changes a channel by various methods, and usually uses a sequential search method that changes a channel by a channel up/down command. In other words, a user sequentially changes channels, and directly selects a channel after checking a program being broadcast on each channel.

A recent broadcast receiving apparatus separately provides a list of recommended channels, a list of preferred channels, a key and a menu for displaying a UI screen such as EPG information list and the like. However, most of users do not often use the key/menu for displaying a UI, and in particular, many senior users are only familiar with manipulating a channel up/down key or a number keypad for inputting a channel number without recognizing the existence and function of the special key/menu.

### SUMMARY

An aspect of the exemplary embodiments relates to a display apparatus which assigns a channel number on a channel recommendation screen, thereby allowing a user to more conveniently access to a channel recommendation screen and a controlling method thereof.

According to an exemplary embodiment, there is provided a display apparatus including a communicator configured to receive broadcasting schedule information including address information and time information of a plurality of Internet broadcasting contents matched to each of a plurality of channel numbers, an input unit configured to receive a channel number input, a processor configured to, in response to the input channel number being a channel number assigned to a channel recommendation screen, control the communicator to sequentially receive a plurality of Internet broadcasting contents being broadcast on each of the plurality of channel numbers based on the broadcasting schedule information and a display configured to sequentially display the plurality of Internet broadcasting contents sequentially received on the channel recommendation screen.

Here, the processor controls the display to display a plurality of thumbnail images corresponding to each of the plurality of channel numbers on the channel recommendation screen and controls the communicator to sequentially receive a plurality of Internet broadcasting contents being broadcast on each of the plurality of channel numbers according to an arrangement order of the plurality of thumbnail images displayed on the channel recommendation screen.

The processor may control the communicator to sequentially receive a plurality of Internet broadcasting contents being broadcast on each of the plurality of channel numbers according a sequence of channel numbers.

The processor may, in response to the input channel number being a channel number assigned to a channel recommendation screen, based on the broadcasting schedule information, receive a first content corresponding to address information of an Internet broadcasting content being broadcast on a first channel number among the plurality of channel numbers and display the first content on the channel recommendation screen, and based on the broadcasting schedule information, receive a second content corresponding to address information of the Internet broadcasting content being broadcast on a second channel number among the plurality of channel numbers and display the second content on the channel recommendation screen after displaying the first content.

The processor may, in response to an Internet broadcasting content displayed on the channel recommendation screen being selected, change a channel into a channel corresponding to the selected Internet broadcasting content, and display the Internet broadcasting content corresponding to the changed channel through the display.

Here, the processor may determine a time consumed until channel change after an Internet broadcasting content displayed on the channel recommendation screen has been selected and search an Internet broadcasting content that has been broadcast on the changed channel within the determined time from a present time based on time information in the broadcasting schedule information, and receive the searched Internet broadcasting content based on address information corresponding to the searched Internet broadcasting content and display the content through the display.

The processor may, while an Internet broadcasting content is displayed on the channel recommendation screen, control the display to display a menu for changing a channel into a channel corresponding to the displayed Internet broadcasting content.

The processor may, in response to a predetermined event occurring while the channel recommendation screen is not displayed, control the display to display a menu for entering into the channel recommendation screen and, in response to the menu being selected, determine that a channel number assigned to the channel recommendation screen has been input.

The processor may, in response to a predetermined time being elapsed since a channel has changed, in response to a commercial being broadcast, or in response to less than a predetermined time being left until a currently-broadcast content ends, determine that the predetermined event has occurred.

Meanwhile, a plurality of channel numbers corresponding to each of a plurality of Internet broadcasting contents sequentially displayed on the channel screen may be selected among channel numbers provided by the display apparatus based on at least one of channel ratings, a history of viewed channels, user settings and content provider settings.

The processor may display a channel list including an item corresponding to a channel number assigned to the channel recommendation screen and an item corresponding to other channel numbers and, in response to an item corresponding to a channel number assigned to the channel recommendation screen being selected on the channel list, determine that a channel number assigned to the channel recommendation screen has been input.

The processor, in response to determining that a new Internet broadcasting content is to be broadcast within a predetermined time from a present time on a channel number corresponding to an Internet broadcasting content being displayed on the channel recommendation screen based on the broadcasting schedule information, controls the display to display introduction information about the new Internet broadcasting content on the channel recommendation screen.

The processor may control the display to display a menu for setting a reservation for watching the new Internet broadcasting content on the channel recommendation screen.

Meanwhile, control method of the display apparatus includes receiving broadcasting schedule information including address information and time information of a plurality of Internet broadcasting contents matched to each of a plurality of channel numbers, receiving a channel number input and, in response to the input channel number being a channel number assigned to a channel recommendation screen, sequentially receiving a plurality of Internet broadcasting contents being broadcast on each of the plurality of channel numbers based on the broadcasting schedule information and sequentially displaying the plurality of Internet broadcasting contents sequentially received on the channel recommendation screen.

Here, the channel recommendation screen includes a plurality of thumbnail images corresponding to each of the plurality of channel numbers, and the sequentially displaying may receive a plurality of Internet broadcasting contents being broadcast on each of the plurality of channel numbers according to an arrangement order of the plurality of thumbnail images displayed on the channel recommendation screen, and sequentially display the plurality of Internet broadcasting contents sequentially received on the channel recommendation screen.

The sequentially displaying may include receiving a plurality of Internet broadcasting contents being broadcast on each of the plurality of channel numbers, and sequentially displaying the plurality of Internet broadcasting contents sequentially received on the channel recommendation screen.

The sequentially displaying may include based on the broadcasting schedule information, receiving a first content corresponding to address information of an Internet broadcasting content being broadcast on a first channel number among the plurality of channel numbers and displaying the first content on the channel recommendation screen, and based on the broadcasting schedule information, receiving a second content corresponding to address information of an Internet broadcasting content being broadcast on a second channel number among the plurality of channel numbers and displaying the second content on the channel recommendation screen after displaying the first content.

Meanwhile, according to an exemplary embodiment, the control method of a display apparatus may further include, in response to an Internet broadcasting content displayed on the channel recommendation screen being selected, displaying the internet broadcasting content corresponding to the changed channel after changing a channel into a channel corresponding to the selected Internet broadcasting content.

According to an exemplary embodiment, the control method of a display apparatus may further include, in response to a predetermined event occurring while the channel recommendation screen is not displayed, displaying a menu for entering into the channel recommendation screen and, in response to the menu being selected, determining that a channel number assigned to the channel recommendation screen has been input.

A recording medium capable of identifying a computer to implement a control method of a display apparatus, the control method includes receiving broadcasting schedule information including address information and time information of a plurality of Internet broadcasting contents matched to each of a plurality of channel numbers, receiving a channel number input and, in response to the input channel number being a channel number assigned to a channel recommendation screen, sequentially receiving a plurality of Internet broadcasting contents being broadcast on each of the plurality of channel numbers based on the broadcasting schedule information and sequentially displaying the plurality of Internet broadcasting contents sequentially received on the channel recommendation screen.

### BRIEF DESCRIPTION OF THE DRAWINGS

FIG. 1 is a diagram illustrating a content providing system according to an exemplary embodiment;

FIG. 2 is a block diagram illustrating a configuration of a display apparatus according to an exemplary embodiment;

FIGS. 3 and 4 are diagrams illustrating various exemplary embodiments of a method of displaying a channel recommendation screen;

FIGS. 5 and 6 are diagrams illustrating various embodiments of a channel recommendation screen according to an exemplary embodiment;

FIG. 7 is a diagram illustrating a channel changing method according to an exemplary embodiment;

FIG. 8 is a diagram illustrating a detailed notice window provided on a channel recommendation screen according to an exemplary embodiment;

FIG. 9 is a diagram illustrating a content payment window provided on a channel recommendation screen according to an exemplary embodiment;

FIG. 10 is a diagram illustrating a menu for entering into a channel recommendation screen according to an exemplary embodiment; and

FIG. 11 is a flow chart illustrating a controlling method of a display apparatus according to an exemplary embodiment.

### DETAILED DESCRIPTION

Hereinafter, the terms used in the description will be described briefly, and exemplary embodiments will be described in more detail with reference to the accompanying drawings.

With respect to the terms used in an example embodiment of the disclosure, general terms currently and widely used are selected in view of function with respect to the disclosure. However, the terms may vary according to an intention of a technician practicing in the pertinent art, an advent of new technology, etc. In specific cases, terms may be chosen arbitrarily, and in this case, definitions thereof will be described in the description of the corresponding disclosure. Accordingly, the terms used in the description should not necessarily be construed as simple names of the terms, but be defined based on meanings of the terms and overall contents of the present disclosure.

The example embodiments may vary, and may be provided in different example embodiments. Various example embodiments will be described with reference to accompanying drawings. However, this does not necessarily limit the scope of the example embodiments to a specific embodiment form. Instead, modifications, equivalents and replacements included in the disclosed concept and technical scope of this description may be employed. While describing example embodiments, if it is determined that the description regarding a known technology obscures the gist of the invention, a detailed description may be omitted.

The term such as “first” “second”, and so on may be used to explain a variety of elements, but the elements should not be limited thereto. The terms are used to distinguish one entity from another entity, without necessarily implying any actual relationship or order between such entities.

A singular term includes a plural form unless otherwise indicated. The terms, “include,” “comprise,” “is configured to,” etc. of the description are used to indicate the existence of features, numbers, steps, operations, elements, parts or combination thereof, and do not exclude the possibilities of combination or addition of one or more features, numbers, steps, operations, elements, parts or combination thereof.

In an example embodiment, ‘a module’ or ‘a unit’ performs at least one function or operation, and may be realized as hardware, software, or combination thereof. Further, except the “modules” or “units” that have to be implemented by certain hardware, a plurality of “modules” or a plurality of “units” may be integrated into at least one module and realized as at least one processor (not illustrated).

In an exemplary embodiment, in the case where a part is “connected” to another part, the case also includes a case where the part is “electrically connected” to the other part with another element interposed therebetween.

Hereinafter, the example embodiments will be described in greater detail in a manner that will be understood by one of ordinary skill in the art. The example embodiments may be implemented by various forms, and is not limited to the example embodiments described herein. Further, those that are irrelevant with the description are omitted so as to describe exemplary embodiments more clearly, and similar drawing reference numerals are used for the similar elements throughout the description.

Hereinafter, the present disclosure will be described in detail with reference to the accompanying drawings.

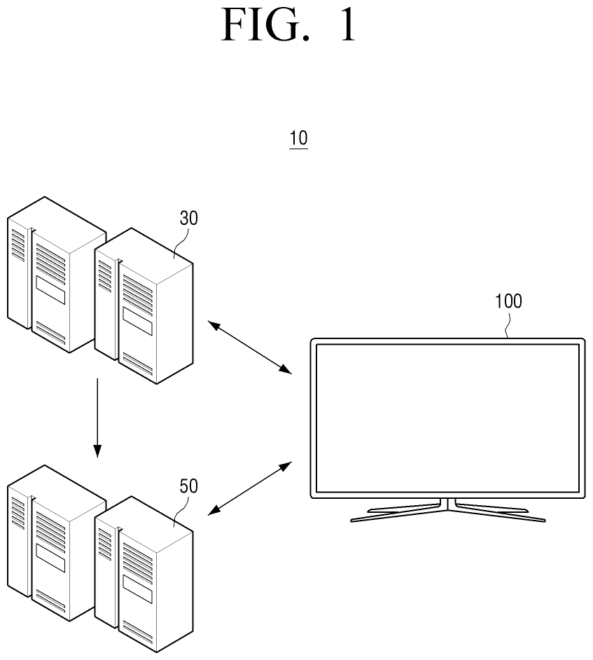

FIG. 1 is a diagram illustrating a content providing apparatus 10 according to an exemplary embodiment. The content providing apparatus 10 may include a content providing server 30, schedule information providing server 50 and a display apparatus 100. According to an exemplary embodiment, an electronic apparatus 100 may be a TV, but this is merely one exemplary embodiment, and may be implemented by various electronic apparatus such as a set-off box, a smart phone, a tablet PC, a note book PC, a desk top PC and the like.

A content providing server 30 provides information about an Internet broadcasting content to a schedule information providing server 50. Here, an Internet broadcasting content is a content broadcast by a streaming method, and has a predetermined broadcasting schedule. The type of an internet broadcasting content may not be limited. For example, an Internet broadcasting content may not only include a content including an image and an audio, but also include a content consisting solely of images or a content consisting solely of audio (e.g., a radio broadcast content, a music broadcast content etc.).

Here, the information about an Internet broadcasting content may include a content address on the content providing server 30 (e.g., Uniform Resource Locator [URL]), a broadcasting time of a content, a name of a content, a producer of a content, cast members, a runtime and the like.

Meanwhile, in FIG. 1, it is described that there is one content providing server 30, but this is just one exemplary embodiment. The content providing server 30 may be embodied as two or more servers. In the case, a content providing server 30 can exist for each content provider.

The schedule information providing server 50 may assign channel numbers for a plurality of Internet broadcasting contents based on information about an Internet broadcasting content received, generate a broadcasting schedule information by mapping information of a channel number, a channel name, a name of broadcasting content at each broadcasting time, a content address at each broadcasting time, and provide the generated broadcasting schedule information to the electronic apparatus 100. The broadcasting schedule information may include, for instance, time information indicating that episode 1 of TV show Friends is scheduled to be broadcast on a channel 501 on Jan. 1, 2016, and address information of episode 1 of Friends on the content providing server 50.

Although, in the above exemplary embodiment, it is described that the schedule information providing server 50 generates broadcasting schedule information only for a plurality of Internet broadcasting contents and provides the information to the electronic apparatus 100, this is merely one exemplary embodiment. The schedule information providing server 50 may acquire not only the information about an Internet broadcasting content but also all the information about a channel corresponding to an Internet broadcasting channel, a terrestrial channel, a cable channel, a satellite channel and the like, generate an integrated schedule information in which all the information about a channel corresponding to an Internet broadcasting channel, a terrestrial channel, a cable channel and a satellite channel and the like are combined, and provides the integrated schedule information to the electronic apparatus 100.

The electronic apparatus 100 stores received broadcasting schedule information. Also, the electronic apparatus 100 may request the content providing server 30 to provide a content based on address information of an Internet broadcasting content being broadcast on a channel number currently selected based on broadcasting schedule information, and receive the content from the content providing server 30 and output the content. In particular, the electronic apparatus 100 may, in response to a channel number assigned to a channel recommendation screen being input, sequentially receive a plurality of Internet broadcasting contents being broadcast on each of the plurality of predetermined channel numbers, and sequentially output the plurality of Internet broadcasting contents sequentially received based on broadcasting schedule information.

Therefore, a user does not need to enter into a separate menu to watch a content or to access to an Internet to watch an Internet broadcasting content through a web browser, but a user may receive and watch an Internet broadcasting content only through manipulation of changing a channel number. Further, a user may receive real time information about contents being broadcasting on channels only through manipulation of inputting a channel number assigned to a channel recommendation screen.

Here, in the case in which the electronic apparatus 100 is a display apparatus such as a TV, the electronic apparatus 100 may display a received Internet broadcasting content. In addition, in the case in which the electronic apparatus 100 is a set-top box, the electronic apparatus 100 may provide a received Internet broadcasting content to another electronic apparatus having a display.

According to the exemplary embodiments described above, a user may also approach an Internet broadcasting content by a familiar method called ‘changing a channel.’ Moreover, using the familiar method of changing a channel, a user may approach a channel recommendation screen which introduces a content currently being broadcast on channels.

Meanwhile, in the exemplary embodiment above, it is described that the content providing server 30 and the schedule information providing server 50 are separated. However, it is merely one exemplary embodiment, and the content providing server 30 and the schedule information providing server 50 may be embodied as one server, and the schedule information providing server 50 may be provided inside the electronic apparatus 100 in a form of a module.

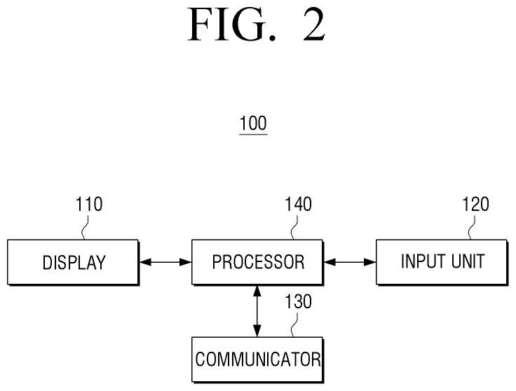

FIG. 2 is a block diagram illustrating a configuration of the case where the electronic apparatus of FIG. 1 is implemented by a display apparatus 100.

The display apparatus 100 includes a display 110, an input unit 120, a communicator 130, e.g., a transceiver, and a processor 140, e.g., a microprocessor. The display apparatus 100 may be a TV, but it is just one exemplary embodiment. The display apparatus 100 may be implemented by various electronic apparatuses such as a smartphone, a tablet PC, a laptop, a desktop and the like.

The display 110 is for displaying various screens. The display 110 may be, for instance, implemented by a Liquid Crystal Display (LCD), and also implemented by cathode-a ray tube (CRT), a plasma display panel (PDP), organic light emitting diodes (OLED), a transparent OLED (TOLED) and the like in some embodiments. Also, the display 110 may be implemented as a form of a touch screen which can detect a touch manipulation of a user.

The input unit 120 is for receiving a control command input to control the display apparatus 100.

The input unit 120 may be, for example, implemented by various input devices such as a button, a pointing device, a mouse, a keyboard, a voice recognition device, a motion recognition device, a touch panel and the like.

Further, the input unit 120 may receive a control command corresponding to a user manipulation from a remote control device (not illustrated) which is for controlling the display apparatus 100. In this case, the input unit 120 may be, for example, implemented by an apparatus including photo diodes to light-receive an IR signal generated in the remote control device.

The communicator 130 may perform communication with various external apparatuses. As an example, the communicator 130 may include various types of communication chips such as a Wi-Fi chip, a Bluetooth chip, an NFC chip, a wireless communication chip and the like. Here, a Wi-Fi chip, a Bluetooth chip and an NFC chip perform communication by a method of LAN, Wi-Fi, of Bluetooth and NFC, respectively. The NFC chip is a chip which operates by a method of Near Field Communication (NFC) using 13.56 MHz among various RF-ID frequencies such as 135 kHz, 13.56 MHz, 433 MHz, 860˜960 MHz, 2.45 GHz etc. In the case in which a Wi-Fi chip or a Bluetooth chip is used, various connection information such as an SSID and a session key may be firstly transmitted and received, and using the connection information, communication connection may be performed, and various information may be transmitted. The wireless communication chip may be a chip which performs communication according to various communication standards such as IEEE, ZigBee, 3rd Generation (3G), 3rd Generation Partnership Project (3GPP), Long Term Evolution (LTE), and the like.

In particular, the communicator 130 may receive broadcasting schedule information including address information and time information of a plurality of Internet broadcasting contents matched to each of a plurality of channel numbers from the information providing server 50. Also, the communicator 130 may receive an Internet broadcasting content in a form of streaming from the content providing server 30 based on address information of an Internet broadcasting content (e.g., a URL address) included in broadcasting schedule information.

Further, the communicator 130 may include a tuner, a cable terminal, a satellite communication module, and using these elements, the communicator 130 may receive broadcasting contents corresponding to a terrestrial channel, a satellite channel and a cable channel from an external broadcasting station.

The processor 140 is a configuration for controlling an overall operation of the display apparatus 100. The processor 140 may include a CPU, a RAM, a ROM and a system bus. In the above exemplary embodiment, it is described that the processor 140 includes one CPU, but the processor 140 may be implemented as a plurality of CPUs (or a DSP, a SoC, etc.) in actual implementation.

The processor 140 may control the communicator 130 to receive broadcasting schedule information including address information (e.g., a URL address) and time information of an Internet broadcasting content matched to each of a plurality of channel numbers.

The broadcasting schedule information may not only include time information of an internet broadcasting content, but also time information of a terrestrial broadcasting content, a cable broadcasting content and a satellite broadcasting content.

In addition, the processor 140 may display broadcasting schedule information as an Electronic Program Guide (EPG) through the display 110.

Broadcasting schedule information displayed through the display 110 may include channel numbers assigned to each of contents of various broadcasting types such as Internet broadcasting, terrestrial broadcasting, cable broadcasting and satellite broadcasting, etc., names of the channels and names of broadcasting contents broadcast at each time on each channel.

The processor 140 may, in the case in which a channel number is input and the input channel number corresponds to an Internet broadcasting channel, control the communicator 130 to receive an Internet broadcasting content currently scheduled on the corresponding channel based on broadcasting schedule information.

For example, if episode 1 of TV show Friends is currently scheduled to begin on channel 501 which is an Internet broadcasting channel, in response to the channel number 501 being input, the processor 140 may control the communicator 130 to receive episode 1 of Friends from the beginning based on time information and address information in the broadcasting schedule information. As another example, if 15 min:45 sec part of episode 1 of Friends is currently scheduled to be broadcast on channel 501, in response to the channel number 501 being input, the processor 140 may control the communicator 130 to receive episode 1 of Friends from a picture of 15 min:45 sec of episode 1 of Friends based on time information and address information in the broadcasting schedule information

The processor 140 may, in response to a channel number being input through the input unit 120 and the input channel number being a channel number assigned to a channel recommendation screen, control the communicator 130 to sequentially receive a plurality of Internet broadcasting contents being broadcasting on each of a plurality of predetermined channel numbers based on broadcasting schedule information.

In case of the above, the plurality of predetermined channel numbers may have been chosen for channel numbers to be recommended on a channel recommendation screen among channel numbers that the display apparatus 100 provides. The channel numbers to be recommended on a channel recommendation screen may be chosen based on one of channel ratings, a history of viewed channels, user settings and content provider settings.

The processor 140 may sequentially receive Internet broadcasting contents according to a predetermined order. For example, the processor 140 may control the communicator 130 to display a plurality of thumbnail images corresponding to each of the plurality of channel numbers and to sequentially receive a plurality of Internet broadcasting contents being broadcast on each of the plurality of channel numbers according to an arrangement order of the plurality of thumbnail images displayed on the channel recommendation screen. Or, the processor 140 may control the communicator 130 to receive a plurality of Internet broadcasting contents being broadcast on each of the plurality of channel numbers according to numerical order. Or, the processor 140 may control the communicator 130 to sequentially receive a plurality of Internet broadcasting contents being broadcast on each of the plurality of channel numbers in the order of channel ratings from highest to lowest, in the order that channels are most frequently viewed by a user of the display apparatus 100, in the order of a channel sequence set by a user of the display apparatus 100 or a channel sequence set by a content provider.

Further, the processor 140 may control the display 110 to sequentially display a plurality of Internet broadcasting contents sequentially received on a channel recommendation screen.

Specifically, the processor 140 may, in response to channel number assigned to a channel recommendation screen being input, receive a content corresponding to address information of an Internet broadcasting content being broadcast on a first channel number among the plurality of channel numbers based on broadcasting schedule information and display the content on a channel recommendation screen, and receive a content corresponding to address information of an Internet broadcasting content being broadcast on a second channel number among the plurality of channel numbers based on the broadcasting schedule information and display the content on the channel recommendation screen.

In the above case, the time during when each Internet broadcasting content is displayed on a channel recommendation screen may be set less than 1 minute approximately in order to show various contents to a user. However, it may not be limited to exactly less than 1 minute, but may also be more than 1 minute.

As an example, in the case in which channel 501 and channel 502 are recommended for 15 seconds each on a channel recommendation screen, the processor 140, in response to a channel number assigned to a channel recommendation screen being input, receives a first content corresponding to a URL address of a content to be broadcast for 15 seconds from the present time on channel 501 based on broadcasting schedule information, and displays the received first content on the channel recommendation screen. When the displaying of the first content for 15 seconds ends, the processor 140 receives a second content corresponding to a URL address of a content to be broadcast on channel 502 based on broadcasting schedule information, and displays the received second content on the channel recommendation screen.

In this way, the processor 140 may sequentially receive a plurality of Internet broadcasting contents and display the contents on a channel recommendation screen. However, it is not limited to this one embodiment, but the processor 140 may also receive in advance a second content to be subsequently displayed, and display the second content right after a first content seamlessly.

Meanwhile, contents sequentially displayed on a channel recommendation screen may include not only a content currently being broadcast but also a content to be broadcast in the future. In this case, information about a content to be broadcast in the future such as a preview image, a plot or highlights may be sequentially displayed along with other Internet broadcasting contents on a channel recommendation screen. Also, along with information about the content to be broadcast in the future, a menu for making a reservation for watching the content may also be provided on a channel recommendation screen.

According to the exemplary embodiment described above, a user may check contents being broadcast or to be broadcast in the future on various channels all at once through a channel recommendation screen without changing a channel to a respective channel.

As a user may access to a channel recommendation screen by a method of selecting a channel number, a user may access to a channel recommendation screen by a familiar method same as the method used in accessing to a general channel, thereby user convenience may improve.

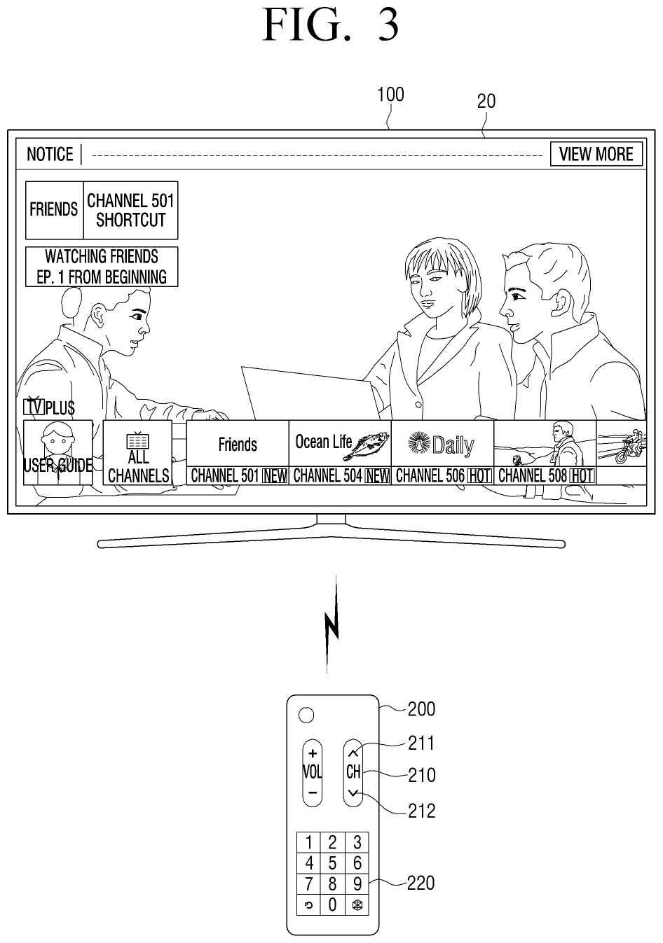

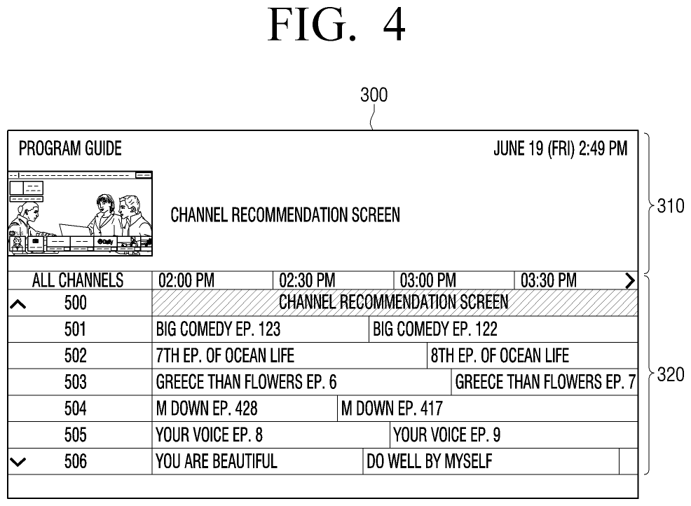

FIGS. 3 and 4 will be described with regard to various methods for receiving a channel recommendation screen.

According to FIG. 3, the display apparatus 100 may receive a control command from a remote control device 200 which controls the display apparatus 100. Here, the input unit 120 may be implemented as an IR signal device to receive an IR signal, and receive an IR signal as a control command.

Specifically, the input unit 120 may receive a channel number assigned to a channel recommendation screen 20 on the display apparatus 100 by manipulation of a channel number key pad 220 or a channel change key 210 in the remote control device 200.

As an example, in the case in which a channel recommendation screen 20 has been assigned to channel number 500, and a user pushes the number 500 on a channel number key pad 220, the display apparatus 100 may display a channel recommendation screen 20 as shown in FIG. 3.

As another example, when a current channel of the display apparatus 100 is 499, and if a user pushes a UP button 211 of the channel change key 210, or when a current channel is 501, and if a user pushes a DOWN button 212 of the channel change key 210, the display apparatus 100 may display a channel recommendation screen 20 as shown in FIG. 3.

As such, a user may receive a channel recommendation screen by selecting a channel number in a remote control device 200. Meanwhile, although it is described that a channel number is selected through a remote control device 200, a channel number may be selected through buttons, etc. provided in the display apparatus 100.

FIG. 4 is a diagram illustrating a method for displaying a channel recommendation screen according to another exemplary embodiment.

FIG. 4 illustrates a channel list 300 which can be displayed on the display apparatus 100. The channel list 300 is based on broadcasting schedule information received from the schedule information providing server 50. The channel list 300 may be an EPG.

The processor 140 may, in response to an item corresponding to a channel number assigned to the channel recommendation screen on the channel list 300, determine that the channel number assigned to the channel recommendation screen has been input.

The channel list 300 may include a list area 320 displaying channel items corresponding to channel numbers and a channel information providing area 310 showing information about a respective channel for an item selected in the list area.

Specifically, the list area 320 may include an item corresponding to at least one of a terrestrial channel number, a satellite channel number, a cable channel number and an Internet channel number, and an item corresponding to a channel number assigned to a channel recommendation screen. In this case, the channel list 300 may include an item corresponding to a channel number assigned to a channel recommendation screen and an item corresponding to another channel number together in an identical form. As an example, in the list area 320 of the channel list 300, an item corresponding to a channel number assigned to a channel recommendation screen (channel number 500 in FIG. 4) may be displayed along with an item corresponding to channel numbers assigned to general channel numbers such as a terrestrial channel in an identical form as shown in FIG. 4.

Here, a user may place a cursor at one item in the list area 320 through a direction key of a remote control device, and select the item in which the cursor is placed through a selecting key of the remote control device. In the state in which only a cursor is placed before selecting a certain item, information about a content broadcast on a channel number corresponding to the certain item on the channel information providing screen 310. For example, on the channel information providing area 310, a content being broadcast may be displayed as a small screen, and text describing the content may be displayed.

As shown in FIG. 4, in the case in which a cursor (a highlight) is placed on an item corresponding to channel number 500, on the channel information providing area 310, a content recommendation screen being shown on channel number 500 may be displayed as a small screen, and text describing the channel recommendation screen may be displayed. In this state, when a select key of a remote control device is pushed, the number 500 which is a channel number assigned on the channel recommendation screen is input, and the display apparatus 100 may display the channel recommendation screen.

As described FIGS. 3 and 4, according to an exemplary embodiment, a channel recommendation screen may be provided in the same way as the way to enter into a general channel such as a terrestrial channel, a satellite channel, a cable channel, an Internet broadcasting channel and the like, therefore, there is an advantage that a user who is only familiar with general manipulations such as changing a channel, changing a volume, etc. may be provided with a channel recommendation screen more conveniently.

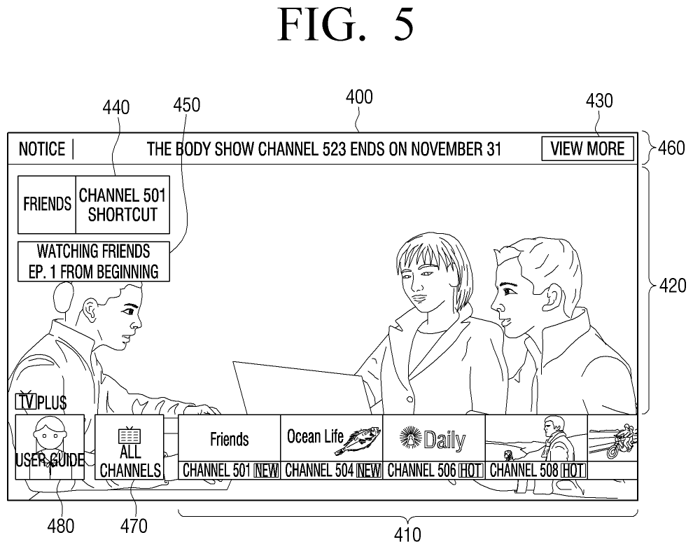

FIG. 5 is a diagram illustrating a channel recommendation screen according to an exemplary embodiment.

A channel recommendation screen 400 may include a channel item list 410, a content providing area 420, a notice area 460, an entry point to detailed notice 430, a channel shortcut menu 440, a Video on Demand (VoD) menu 450, a user guide menu 480 and a channel list menu 470.

The channel item list 410 may include at least one of items corresponding to Internet broadcasting channels, and each item may include a channel number and an icon (or a thumbnail image) corresponding to a respective channel. Each item of the channel item list 410 is a UI element which can be selected through a remote control device or the like.

When one item being selected in the channel item list 410, the processor may receive an Internet broadcasting content currently broadcast on a respective channel corresponding to the selected item from the content providing server 30 based on address information included in schedule information, and control the display 110 to display the received content on the content providing area 420.

Here, the channel item list 410 may include items corresponding to every channel number except for a channel number assigned to the channel recommendation screen 400.

Or, the channel item list 410 may include only an item corresponding to a predetermined recommendation channel. As an example, a plurality of recommended channels may be determined based on at least one of viewer ratings, a history of viewed channels, a history of contents payment, user settings and content provider settings, and an item corresponding to the plurality of determined recommendation channel may be included in the channel item list 410. In the case in which a channel item list is configured based on a history of viewed channels, it is also possible to recommend a channel by different genres that a user prefers.

The arrangement order of items in the channel item list 410 may follow an order determined by a user, an order determined by a content provider, an order of higher channel ratings, an order of channels mostly watched, an order of channels the most currently assigned and the like.

Further, the channel item list 410 may be scrolled. According to FIG. 5, the items existing on the outside of the right side of the channel recommendation screen 400 may be scrolled and provided on the channel recommendation screen 400.

The content providing area 420 is an area where a plurality of Internet broadcasting contents being currently broadcast are provided in real time. That is, a content being broadcast on a channel number other than a channel number assigned to a channel recommendation screen is equally provided on the content providing area 420. Therefore, a user may check various Internet broadcasting contents through the content providing area 420 without changing a channel into another channel.

In particular, a plurality of Internet broadcasting contents currently being broadcast may be sequentially displayed for each predetermined time on the content providing area 420.

For example, based on a broadcasting schedule information, in the case in which a 10 min:00 sec part of episode 1 of TV show Friends is scheduled on a first channel number at 4:05 PM which is a present time, the processor 140, based on address information corresponding to a part to be broadcast on the first channel number for 1 minute from the present time, that is, based on address information corresponding to the part from 10 min:00 sec to 11 min:00 sec of episode 1 of Friends, receives the part from 10 min:00 sec to 11 min:00 sec of episode 1 of Friends from the content providing server 30, and displays the part on the content providing area 420. Then, the processor 140, in the case in which a 05 min:00 sec part of episode 1 of TV show Big Bang is scheduled on a second channel at 4:06 PM, the processor 140, based on address information corresponding to a part to be broadcast on the second channel number from 4:06 PM to 4:07 PM, that is, based on address information corresponding to the part from 05 min:00 sec to 06 min:00 sec of episode 1 of Big Bang, receives the part from 05 min:00 sec to 06 min:00 sec of episode 1 of Big Bang from the content providing server 30, and displays the part right after the part from 10 min:00 sec to 11 min:00 sec of episode 1 of Friends is displayed.

In this way, a plurality of Internet broadcasting contents being broadcast on the first channel number and the second channel number may be sequentially recommended on the content providing area 420. Meanwhile, in the example described above, although it is described as only two channel numbers are recommended on the content providing area 420, it is also possible to recommend more than 2 channel numbers. Moreover, it is described as contents are provided for 1 minute each, but the time is not limited to 1 minute, and it is also possible to provide contents for less than or more than 1 minute.

According to an exemplary embodiment, Internet broadcasting contents being sequentially displayed on the content providing area 420 may correspond to an item of the channel item list 410.

According to another exemplary embodiment, Internet broadcasting contents being sequentially displayed on the content providing area 420 may correspond to a recommended channel determined based on at least one of channel ratings, a history of viewed channels, user settings, content provider settings and the like.

Specifically, the processor 140 may receive information about channel ratings from an external server, determine several top-rated channels in the channel ratings as channels to be recommended in the channel recommendation screen based on the received information, sequentially receive Internet contents being broadcast on the channels determined as recommended channels, and sequentially display the contents on the content providing area 420.

The processor 140 may store information about channels that a user has watched as a history of viewed channels, and determine several mostly-watched channels as channels to be recommended on the channel recommendation screen based on the history of viewed channels stored, sequentially receive Internet contents being broadcast on the channels determined as recommended channels, and sequentially display the contents on the content providing area 420.

The processor 140 may also display a UI screen to select channels to be recommended in a channel recommendation screen through a display 110, and determine the channels selected through the UI screen as recommended channels, sequentially receive Internet contents being broadcast on the channels determined as recommended channels, and sequentially display the contents on the content providing area 420.

Further, channels to be recommended in the channel recommendation screen may be determined by a content provider according to an advertisement purpose, and the processor 140 may receive information about the determined channels from a content provider (e.g., the content providing server 30), sequentially receive Internet contents being broadcasting on the channels determined by a content provider based on the information received, and display the contents on the content providing area 420.

The order of Internet broadcasting contents to be sequentially displayed on the content providing area 420 may follow an arrangement order of items in the channel item list 410. As shown in FIG. 5, items in the channel item list 410 are arranged in the order of channel 501, channel 504, channel 506 and channel 508, and thus, Internet broadcasting contents are sequentially displayed on the content providing area 420 following the order of channel 501, channel 504, channel 506 and channel 508. The arrangement order of items arranged in the content providing area 420 may be an order of a higher channel ratings, an order of channels more frequently watched, an order set by a user, an order set by a content provider, an order of a higher channel number and the like.

Meanwhile, in the content providing area 420, not only an Internet broadcasting content being broadcast but also information about an Internet broadcasting content to be broadcast in the future may be provided.

Specifically, the processor 140 may, when it is determined that a new Internet broadcasting content is to be broadcast within a predetermined time from a present time on a channel number corresponding to an Internet broadcasting content being displayed on the content providing area 420 based on the broadcasting schedule information, controls the display to display 110 introduction information of the new Internet broadcasting content on the channel recommendation screen 400.

Further, the processor 140 may, when it is determined that an advertisement is currently broadcast on the channel number corresponding to an Internet broadcasting content displayed in the content providing area 420, and that a certain Internet broadcasting content is to be broadcast after the advertisement ends based on a broadcasting schedule information, control the display 110 to display introduction information about the Internet broadcasting content on the channel recommendation screen 140.

The processor 140 may, in the case in which there is less than a predetermined time is left until a content broadcast on a channel number corresponding to an Internet broadcasting content which is being displayed in the content providing area ends based on broadcasting schedule information, control the display 110 to display introduction information about a content to be broadcasted after the content on the channel recommendation screen 400.

Here, the introduction information may include a name of a content, a preview image, a plot or highlights, and these information may be provided from the content providing server 30.

Meanwhile, the processor 140 may control the display 110 to display not only the introduction information about the new Internet broadcasting content but also display a menu for setting a reservation for watching the new Internet broadcasting content through the channel recommendation screen 400.

Specifically, the processor 140 may, in response to the menu for setting the reservation for watching the new Internet broadcasting content, automatically change a channel number to a respective channel number at the time when the new Internet broadcasting content begins based on the broadcasting schedule information.

According to the exemplary embodiment described above, not only a content being broadcasting through the channel recommendation screen 400 but also a content to be broadcast in the future may be provided.

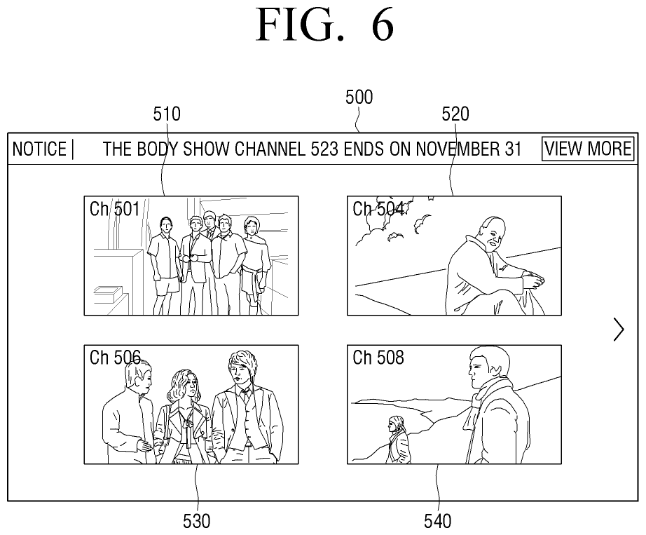

Meanwhile, in FIG. 5, it is described that there is one content providing area, but there can be a plurality of content providing areas. As illustrated in FIG. 6, the channel recommendation screen 500 may include a plurality of content providing areas 510, 520, 530 and 540. In this case, a user may check all the Internet broadcasting contents being broadcast on various channel numbers all at once.

Hereinafter, a method for changing a channel to a recommended channel through the channel recommendation screen 400 will be described.

Specifically, the processor 140 may, in response to an Internet broadcasting content displayed on the channel recommendation screen 400, changes a channel to a channel corresponding to the selected Internet broadcasting content, and display an Internet broadcasting content corresponding to the changed channel on the display 110.

As an example of selecting an Internet broadcasting content displayed on the channel recommendation screen 400, there is a method of selecting a channel shortcut menu 440.

Specifically, the channel shortcut menu 440 is a menu for entering into a channel corresponding to a content displayed on the content providing area 420. Hence, in the case in which a content changes in the content providing area 420, a channel number mapped in the channel shortcut menu 440 also changes.

The channel shortcut menu 440 may include a logo of a respective channel number. Also, a focus (or a cursor) is placed on the channel shortcut menu 440, the logo may be display as a moving flash image.

Further, information of a runtime left of an Internet broadcasting content being currently broadcast on the respective channel may be displayed on the channel shortcut menu 440.

Meanwhile, in the case in which a channel has changed from channel recommendation screen to a certain channel by selecting the channel shortcut menu 440, there may be a problem that the content shown on the channel recommendation screen and the content shown on the changed channel are not connected to each other.

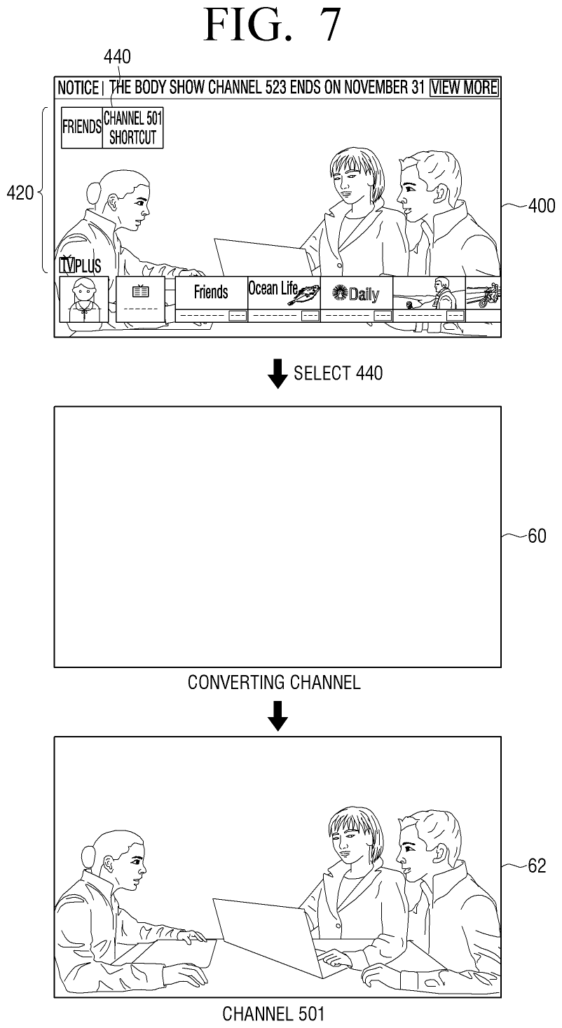

In order to solve the above problem, according to an exemplary embodiment, the processor 140 may determine a time consumed until channel change after an Internet broadcasting content displayed on content providing area 420 has been selected, and search an Internet broadcasting content that has been broadcast on the changed channel within the determined time from a present time based on time information in the broadcasting schedule information, receive the searched Internet broadcasting content based on address information corresponding to the searched Internet broadcasting content and display the content through the display 110. The exemplary embodiment will be described with reference to FIG. 7.

According to FIG. 7, when the shortcut menu 440 is selected while a picture of 00:30 of episode 1 of TV show Friends is displayed in the content providing area 420 of the channel recommendation screen 400, the content is not displayed for two seconds which is for changing a channel as a screen 60 shows. When the changing the channel is completed, the processor 140 may, in consideration of the two seconds which has been spent for changing the channel, control the display 110 to display a picture 62 of 00:30 of episode 1 of Friends instead of a picture currently being broadcast, that is, a picture of 00:32 of episode 1 of Friends, two seconds ahead based on broadcasting schedule information. As such, a user may watch contents seamlessly even when there is a change from the channel recommendation screen 400 to another channel. Meanwhile, the time consumed for changing a channel may be determined by calculating the difference of the time value between the time when the changing of the channel is completed and the time when an Internet broadcasting content displayed in the content providing area 420 is selected. Or, not even by calculating the difference every time, the processor 140 may preset the time consumed for changing a channel in advance, and determine the preset time as a time consumed for changing a channel. Approximately 2 seconds may be determined as a time to be consumed for changing a channel.

As described above, the display apparatus 100 may provide a user with a content by properly adjusting a schedule based on time information and address information of a content which are included in broadcasting schedule information.

Meanwhile, in the case of changing into a respective channel by selecting the shout cut menu 440, a menu for re-entering into a channel recommendation screen may be displayed for a while. As such, if a user does not like a content on the changed channel, a user can return to the channel recommendation screen by selecting the displayed menu.

Referring back to FIG. 5, the rest of the configuration of the channel recommendation screen 400 will be described.

A VoD menu 450 is a menu for watching a VoD content. A VoD is a customized video that a user can watch a content whenever a user wants to regardless of a broadcasting schedule.

When the VoD menu 450 is selected, a VoD content corresponding to an Internet broadcasting content provided in the content providing area 420 may be reproduced. For example, while episode 1 of Friends is being provided on channel 501 in the content providing area 420, and when the VoD menu is selected, the processor 140 may request episode 1 of Friends to the content providing server 30, and reproduce the content on the display apparatus 100.

The difference between the channel shortcut menu 440 and the VoD menu 450 is that, when the channel shortcut menu 440 is selected, a channel is changed, and an Internet broadcasting content currently scheduled is displayed on the changed channel. Hence, if a 00:30 part of episode 1 of Friends is scheduled to be broadcast currently on a changed channel, from the picture of 00:30 of episode 1 of Friends is received and displayed. However, when the VoD menu is selected, regardless of a broadcasting schedule, from the beginning of episode 1 of Friends is received and displayed, or if there is a history that a user has recently watched episode 1 of Friends as a VoD content, from the lastly watched picture is received and displayed based on the history.

As another example, in the case in which a content provided in the content providing area 420 is one of episodes of a TV show, in response to the VoD menu 450 being selected, a respective VoD content for a first episode of the TV show may be displayed on the display apparatus 100. For example, while episode 10 of Friends is displayed on the content providing area 420, a user can watch from episode 1 of Friends by selecting the VoD menu 450.

Meanwhile, in the case in which a user needs to pay for watching a VoD content, a payment page may be displayed when the VoD menu 450 is selected. After the payment is completed on the payment page, a VoD content may be displayed.

In addition, information of VoD content payment may be stored, and a replay menu may be provided for a paid VoD content in the channel recommendation screen 400.

A notice area 460 is an area where various information about a channel can be displayed.

For example, a text notifying that The Body Show on channel 523 is to be ended on November 31 may be displayed on the notice area 460 as illustrated in FIG. 5.

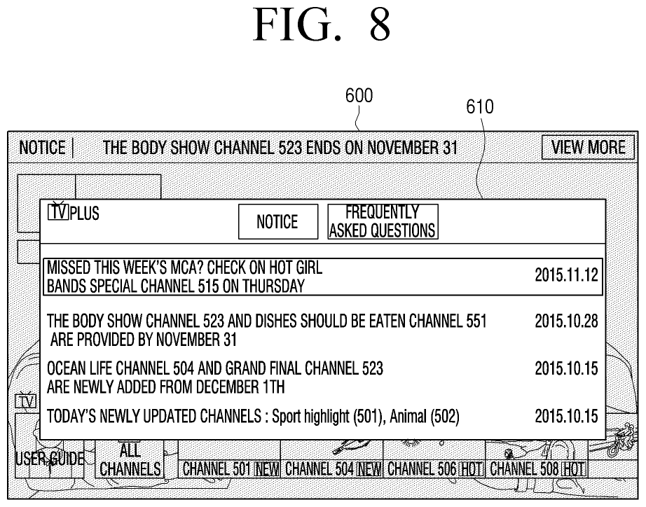

When an entry point of detailed notice 430 is selected, a screen including a detailed notice may be displayed. For example, a detailed notice window 610 may be displayed on a channel recommendation screen 600 as illustrated in FIG. 8. A user can check more notices in the detailed notice area 610, and also check a question that a user has posted in regard to a channel and its answer.

On the entry point of detailed notice 430, a number indicating a newly registered notice or an unread message may be displayed.

When the channel list menu 470 is selected, a processor 140 may display a list of all the channels that the display apparatus 100 provides, or in some cases, display only a list of Internet broadcasting channels. When a user guide menu 480 is selected, a guide for using a channel recommendation screen may be displayed.

Meanwhile, the channel item list 410 may include various items corresponding to various channel numbers, and also include items respective for various channels such as Live TV, Future Broadcasting, a pay channel and the like. On a pay channel, a pay VoD content may be provided. In the case in which a user selects a respective item for a pay channel in the channel item list 410, information about a content provided by the respective channel may be displayed. For example, a respective item for a pay channel is selected, a channel recommendation screen 700 may display a content information providing area 710. In the content information providing area 710, a content of the respective channel may be minimized in a PIG form and displayed, and a description for the respective content, content payment information, etc. may also be displayed.

In the exemplary embodiment described above, it is described that only one channel number is assigned to the channel recommendation screen 400, but according to another exemplary embodiment, a plurality of channel numbers may be assigned to the channel recommendation screen 400. For example, channel number 500, channel number 510 and channel number 520 may be assigned to the channel recommendation screen, and when one of the above channel number is selected, the channel recommendation screen may be displayed.

Therefore, as described above, in the case in which a plurality of channel numbers have been assigned to a channel recommendation screen, the channel recommendation screen may be put between general channels. According to this exemplary embodiment, a channel recommendation screen may be provided while a user pushes a channel change button several times, thereby a user does not need to continuously push a channel change button until a content that a user wants to watch appears.

In the exemplary embodiment described above, a user may enter into a channel recommendation screen by a method of entering directly into a channel number in a remote control device, but according to another exemplary embodiment, the processor 140 may display a menu for automatically entering into a channel recommendation screen at an appropriate time through the display 110. Specifically, the processor 140 may, when a predetermined event occurs while a channel recommendation screen has not been displayed, display a menu for entering into the channel recommendation screen, and when the menu is selected, determine that a channel number assigned to the channel recommendation screen has been input.

Here, the processor 140 may determine that a predetermined event has occurred in the following cases. For example, in the case in which a predetermined time has been elapsed since a channel has changed, in the case in which an advertisement is broadcast, or in the case in which less than a predetermined time is left until a content currently broadcast ends, the processor 140 may determine that the predetermined event has occurred.

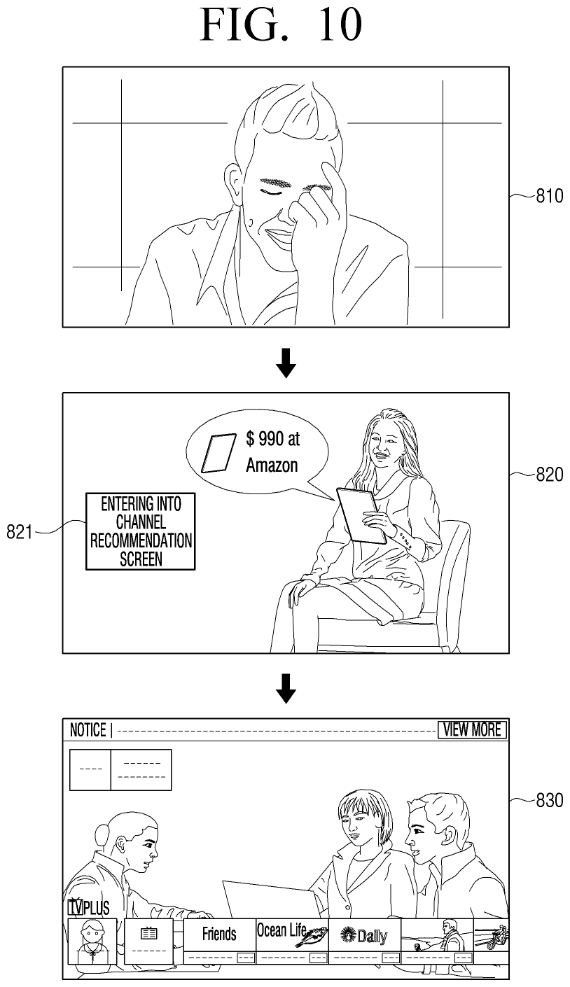

The exemplary embodiment above will be further described with reference to FIG. 10 below. FIG. 10 shows a case in which an event that an advertisement is broadcast has occurred among the various predetermined events described above.

According to FIG. 10, a screen 810 indicates a state in which a channel of a channel number that is different from a channel number assigned to the channel recommendation screen has been selected. Here, it is assumed that the screen 810 is a screen of channel number 501, and channel number 500 has been assigned to a channel recommendation screen.

After a content 810 has been broadcast in channel number 501, when an advertisement 820 is broadcast, the processor 140 controls the display 110 to display a menu 821 for entering into a channel recommendation screen on the advertisement screen.

When a user selects the menu 821 through a remote control device, etc., the processor 140 determines that the channel number 500 has been input, and displays a channel recommendation screen 830. Accordingly, a user can leave the advertisement and watch a content of other channels.

Also, a user's demand for watching another channel generally occurs during a channel change. In other words, a user changes a channel, but if the changed channel is not broadcasting a content that a user wants to watch, a user wants to move into another channel promptly. Therefore, as the menu for entering into the channel recommendation screen needs to be display also in this case, the processor 140 may control the display 110 to display a menu 821 for entering into a channel recommendation screen also in the case in which an event where a predetermined time has been elapsed after a channel has been changed occurs as illustrated in FIG. 10. Meanwhile, the processor 140 may also control the display 110 to display a menu for entering into the channel recommendation screen only when a channel is changed from a channel number assigned to the channel recommendation screen to another channel number rather than to display the menu every time a channel is changed.

The processor 140 may control the display 110 to display a menu which is displayed depending on an event of channel change described above for a certain period of time and then to make the menu disappear. As a result, a menu does not bother a viewing screen as much as possible when a user finally changes a channel into a channel that a user wants to watch.

Even in the case in which less than a predetermined time is left until a content currently being broadcast ends, the same menu 821 for entering into the channel recommendation screen may be displayed as illustrated in FIG. 10.

Meanwhile, in the above case, if a user selects the menu 821 while a user watches a first content which ends soon on a first channel, the processor 140 may display a channel recommendation screen which displays the first content being broadcast on the first channel in real time. That is, a user may not only watch the content that has not ends yet, but also select and watch another channel recommended on the channel recommendation screen at the same time.

Or, when the content that a user is watching ends, the processor 140 may control the display 110 to display a menu for entering into the channel recommendation screen as described in FIG. 10. Thus, a user may move into the channel recommendation screen right after the content ends.

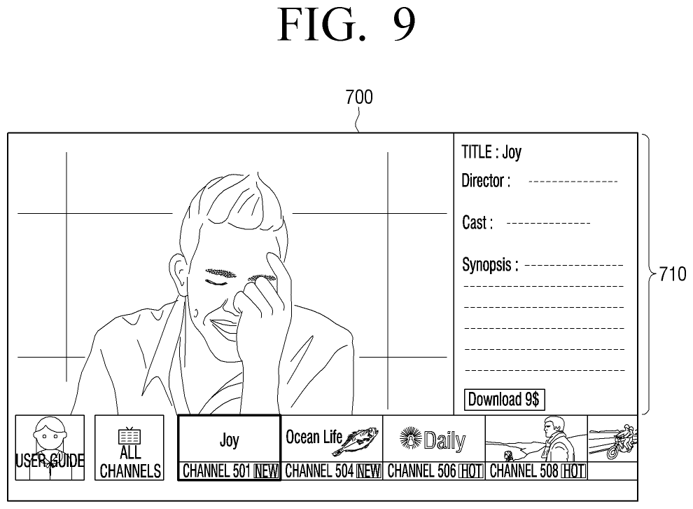

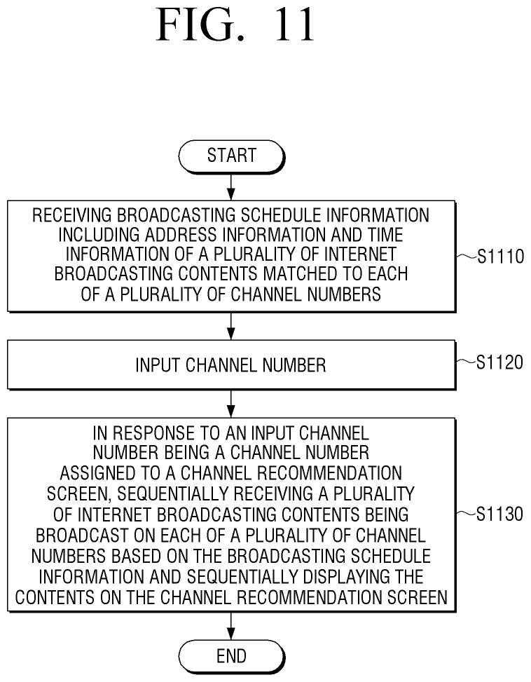

FIG. 11 is a flow chart illustrating a control method of the display apparatus according to an exemplary embodiment. Meanwhile, the control method of the display apparatus not only includes the exemplary embodiment described in FIG. 11 but also includes various exemplary embodiments described through FIGS. 1-10. Therefore, descriptions of such exemplary embodiments which are in a range repetitive to the above-described exemplary embodiments will be omitted.

According to FIG. 11, the display apparatus 100 receives broadcasting schedule information including address information and time information of a plurality of Internet broadcasting contents matched to each of a plurality of channel numbers (operation S1110).

Then, the display apparatus 100 receives a channel number input (operation S1120).

The display apparatus 100, in response to the input channel number being a channel number assigned to a channel recommendation screen, sequentially receive a plurality of Internet broadcasting contents being broadcast on each of the plurality of channel numbers based on the broadcasting schedule information, and sequentially display the plurality of Internet broadcasting contents sequentially received on the channel recommendation screen (operation S1130).

In the above case, the channel recommendation screen may be the same screen as the screen illustrated in FIG. 5, for example, and the plurality of Internet broadcasting contents sequentially received may be displayed on the content providing area 420.

Meanwhile, the channel recommendation screen may include a plurality of thumbnail images corresponding to each of the plurality of channel numbers, and the display apparatus 100 receives a plurality of Internet broadcasting contents being broadcast on each of the plurality of channel numbers according to an arrangement order of the plurality of thumbnail images displayed on the channel recommendation screen, and sequentially displays the plurality of Internet broadcasting contents sequentially received on the channel recommendation screen.

Also, the display apparatus 100 sequentially receives the plurality of Internet broadcasting contents being broadcast on each of the plurality of channel numbers according to the channel number sequence, and sequentially displays the plurality of Internet broadcasting contents sequentially received on the channel recommendation screen. For instance, a plurality of channel numbers are 501, 502 and 503, respectively, the display apparatus 100 may receive the Internet broadcasting contents being broadcasting on each channel in an ascending order as channel 501, channel 502 and channel 503, and sequentially display the contents on the channel recommendation screen.

As described above, the channel recommendation screen may be displayed through an channel number input assigned to a channel recommendation screen, or as described in FIG. 10, may be displayed by selecting a certain menu displayed on the display 110. Or, the channel recommendation screen may be displayed by pushing a key exclusively used for displaying a channel recommendation screen, the key which is provided in a remote control device that controls the display apparatus 100.

Meanwhile, the exemplary embodiments described above can be implemented in an electronic apparatus such as a set-top box which does not have a display, and in this case, the electronic apparatus may have the same elements as the elements of the display apparatus illustrated in FIG. 2 but may not have a display 110, and may transmit a control command which controls the functions of the display 100 to be performed in an external device in which a display is provided through the communicator 130.

The various exemplary embodiments described above may be implemented inside a recording medium such as a computer which can perform a reading by using a software, a hardware or a combination of the two. According to an hardware implementation, the exemplary embodiments described may be implemented by at least one of Application Specific Integrated Circuits (ASICs), digital signal processors (DSPs), digital signal processing devices (DSPDs), programmable logic devices (PLDs), field programmable gate arrays (FPGA), processors, controllers, micro-controllers, microprocessors or an electric unit for performing other functions. In some cases, the exemplary embodiments in this specification will be implemented by the processor 140 itself. According to a software embodiment, the exemplary embodiments such as sequences and functions described in this specification will be implemented by separate software modules. Each of the software modules may perform one or more functions described in this specification.

Meanwhile, the control method of the display apparatus according to the various exemplary embodiments may be stored in a non-transitory readable medium. Such a non-transitory computer readable medium may be used by being mounted on various devices.

A non-transitory computer readable medium may refer to a machine-readable medium or device that stores data semi-permanently and not for a short period of time, such as a register, cache, memory, and the like. The programs for performing the various methods described above may be stored in a non-transitory computer readable medium such as a compact disc (CD), a digital versatile disc (DVD), a hard disk, a Blu-ray disc, a universal serial bus (USB) stick, a memory card, a ROM, etc.

The foregoing exemplary embodiments and advantages are merely exemplary and are not to be construed as limiting the exemplary embodiments. The exemplary embodiments can be readily applied to other types of apparatuses. Also, the description of the exemplary embodiments is intended to be illustrative, and not to limit the scope of the inventive concept, as defined by the appended claims, and many alternatives, modifications, and variations will be apparent to those skilled in the art.

What is claimed is:

1. A display apparatus comprising:
a display;
a transceiver configured to receive a plurality of Internet broadcasting contents;
an input unit configured to receive a user input signal; and
a processor configured to:
in response to receiving, through the input unit, a user input signal for selecting a predetermined virtual channel number, control the display to display information of a plurality of virtual channels,
wherein the plurality of virtual channels correspond to the plurality of Internet broadcasting contents receivable through the transceiver, and
wherein the information of the plurality of virtual channels includes at least one of virtual channel numbers, icons for the plurality of virtual channels and virtual channel names.

2. The display apparatus of claim 1, wherein the information of the plurality of virtual channels further includes an image of a virtual channel among the plurality of virtual channels.

3. The display apparatus of claim 1, wherein the processor is further configured to, based on one of the icons being selected, display Internet broadcasting contents corresponding to the selected icon.

4. The display apparatus of claim 1, wherein the information of the plurality of virtual channels further includes a plurality of thumbnail images corresponding to a plurality of virtual channel numbers.

5. The display apparatus of claim 1, wherein the processor is further configured to display a content providing area, wherein the content providing area is an area where a content of one of the plurality of virtual channels is provided.

6. The display apparatus of claim 1, wherein the processor is further configured to control the transceiver to receive the plurality of Internet broadcasting contents being broadcast on a plurality of virtual channel numbers according to a sequence of the plurality of virtual channel numbers.

7. The display apparatus of claim 1, wherein the transceiver is further configured to receive broadcasting schedule information including an address information and time information of the plurality of Internet broadcasting contents, and
the processor is further configured to:
receive, based on the broadcasting schedule information, a first content corresponding to the address information of an Internet broadcasting content being broadcast on a first virtual channel number among a plurality of virtual channel numbers, control the display to display the first content on a virtual channel guide screen,
receive, based on the broadcasting schedule information, a second content corresponding to the address information of an Internet broadcasting content being broadcast on a second virtual channel number among the plurality of virtual channel numbers, and control the display to display the second content on the virtual channel guide screen after displaying the first content.

8. A control method of a display apparatus, the control method comprising:
in response to receiving a user input signal for selecting a predetermined virtual channel number, displaying an information of a plurality of virtual channels,
wherein the plurality of virtual channels correspond to a plurality of Internet broadcasting contents receivable through a transceiver of the display apparatus, and
wherein the information of the plurality of virtual channels includes at least one of virtual channel numbers, icons for the plurality of virtual channels, and virtual channel names.

9. The control method of claim 8, wherein the information of the plurality of virtual channels further includes an image of a virtual channel among the plurality of virtual channels.

10. The control method of claim 8, further comprising:
based on one of the icons being selected, displaying Internet broadcasting contents corresponding to the selected icon.

11. The control method of claim 8, wherein the information of the plurality of virtual channels further includes a plurality of thumbnail images corresponding to a plurality of virtual channel numbers.

12. The control method of claim 8, wherein displaying further comprises:
displaying a content providing area, wherein the content providing area is an area where a content of one of the plurality of virtual channels is provided.

13. The control method of claim 8, further comprising:
receiving the plurality of Internet broadcasting contents being broadcast on a plurality of virtual channel numbers according to a sequence of the plurality of virtual channel numbers.

14. The control method of claim 8, further comprising:
receiving broadcasting schedule information including an address information and time information of the plurality of Internet broadcasting contents,
receiving, based on the broadcasting schedule information, a first content corresponding to the address information of an Internet broadcasting content being broadcast on a first virtual channel number among a plurality of virtual channel numbers, and displaying the first content on a virtual channel guide screen, and
receiving, based on the broadcasting schedule information, a second content corresponding to the address information of an Internet broadcasting content being broadcast on a second virtual channel number among the plurality of virtual channel numbers, and displaying the second content on the virtual channel guide screen after displaying the first content.
